(19) United States
(12) Patent Application Publication
(10) Pub. No.: US 2013/0266837 A1
(43) Pub. Date: Oct. 10, 2013

(54) HEAT RADIATION PLATE FOR BATTERY MODULE AND BATTERY MODULE HAVING THE SAME

(71) Applicants: Han Saem Lee, Ansan (KR); Kyong Hwa Song, Seoul (KR); Jin Woo Kwak, Suwon (KR); Byung Sam Choi, Suwon (KR)

(72) Inventors: Han Saem Lee, Ansan (KR); Kyong Hwa Song, Seoul (KR); Jin Woo Kwak, Suwon (KR); Byung Sam Choi, Suwon (KR)

(73) Assignee: HYUNDAI MOTOR COMPANY, Seoul (KR)

(21) Appl. No.: 13/546,207

(22) Filed: Jul. 11, 2012

(30) Foreign Application Priority Data
Apr. 4, 2012 (KR) 10-2012-0035117

(51) Int. Cl. H01M 10/50; D04H 1/728; B29C 45/14

(52) U.S. Cl. 429/120; 264/460; 264/446

(57) ABSTRACT

Disclosed is a heat radiation plate for a battery module, which can effectively radiate heat accumulated in a battery module, and the battery module having the heat radiation plate. To this end, the heat radiation plate is inserted in an interlayer manner between battery cells. The heat radiation plate includes high-polymer matrix layers and a filler layer inserted in an interlayer manner between the high-polymer matrix layers, in which the filler layer is made of a conductive fiber having a three-dimensional (3D) web structure.

### CROSS-REFERENCE TO RELATED APPLICATION

This application claims under 35 U.S.C. §119(a) the benefit of Korean Patent Application No. 10-2012-0035117 filed Apr. 4, 2012, the entire contents of which are incorporated herein by reference.

### BACKGROUND

(a) Technical Field

The present disclosure relates to a heat radiation plate for a battery module and the battery module having the same. More particularly, it relates to a heat radiation plate for a battery module, which can effectively radiate heat accumulated in a battery module.

(b) Background Art

For electric vehicles, the reliability and stability of a battery system is one of the most important factors that affects salability. Accordingly, the proper temperature range of the battery system has to be maintained to prevent performance degradation of the battery with respect to a change in the external temperature.

As is well known, however, batteries in an electric vehicle may experience a local temperature difference or reach high temperatures due to heat generated by high power, high speed, repeated charging, etc., and thus thermal runaway may occur which impedes the efficiency and stability of the battery.

The thermal runaway phenomenon is caused by insufficiency of heat radiation and diffusion to the outside of the battery in relation to the amount of to heat generated inside the battery.

A lithium-ion battery can be manufactured in various forms. For example, one form is a pouched type battery cell, which has recently has been increasingly used due its structural flexibility and thus the shape thereof is relatively unrestrained.

These pouched type battery cells typically include a battery portion and a pouched type case having a space for receiving the battery portion therein. The battery portion is generally structured so that a positive plate, a separator, and a negative plate are arranged sequentially in that order and are wound in one direction. Alternatively, several positive plates, separators, and negative plates may be deposited in a multi-layer structure. Because the pouched type case is made of a flexible material, the structure of the case may be freely bent and formed to fit in irregular locations and thus is extremely beneficial in cost reduction and mass production of battery cells.

FIG. 1 is a diagram schematically showing a battery module 30 configured with a plurality of pouched type cells 20. As shown in FIG. 1, the adjacent cells 20 are interconnected through an electrode portion 21, and adjacent cells 20 are disposed at predetermined intervals from each other, e.g., an interval of 3 mm or more.

This interval space between the adjacent cells is a flow path space 22 between the cells 20 through which cooled air is introduced, passes, and is discharged. Accordingly, when the cooled air passes through the flow path space 22 between the cells 20, heat from the cells 20 can be absorbed by the cooled air and radiated to the outside (arrows shown in FIG. 1 indicate the passage directions of the cooled air).

In the pouched type battery cell, during charging and discharging, intercalation and deintercalation of lithium ions into and from an electrode material causes repetition of creation/extinction of an interlayer compound, resulting in a change in volume of the cell. In addition, damage to a separator between electrode materials due to expansion of an electrode in the battery cell causes degradation in the efficiency of the battery, including generation of internal resistance, voltage increase, and reduction in battery performance and ultimate battery capacity. For this reason, there is a need for a heat radiation member which is capable of handling a change in the volume of the battery.

One material for conventional battery case and housing is composed of a plastic-based material, such as PC+ABS, PA, PP, etc., filled with a flame-retardant filler, and a mineral filler at 20-30 weight %. Such a material actually has no heat radiation property in spite of its flame-retardant property, chemical resistance, insulation, durability, and so forth.

Other types of materials which have conventionally been used are plastic complex materials for battery's heat radiation which contain long fibers such as carbon fiber, glass fiber, or the like, or a plate-shape particle such as graphite, boron nitride, or the like as a thermally conductive filler in order to improve the thermal conductivity of a plastic matrix. However, in such a plastic complex material, the thermal conductivity is only superior in a certain direction and the thermal conductivity in all other directions is degraded due to a shear force applied in an injection process, resulting in a reduced radiation of heat generated in the pouched type battery.

Furthermore, in the air cooling scheme of the conventional battery module 30, as shown in FIG. 1, a predetermined interval, e.g., the air path (flow path space) 22 of 3 mm or more has to be maintained between the cells 20, making it difficult to improve the density of energy per unit volume. That is, when the battery module 30 having a particular volume is originally formed, a predetermined interval has to be provided between the cells 20, reducing the number of cells which can be applied within the same volume, such that the degree of freedom of design for improving energy density within the same volume is also limited.

Therefore, there is an urgent need for development of a material which can improve energy density with respect to volume of the battery module, handle a change in volume, remedy anisotropy of thermal conductivity, and improve thermal conductivity.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention has been made in an effort to solve the above-described problems associated with prior art, and provides a heat radiation plate for a battery module, which is a heat radiation interface plate interposed between battery cells of a pouched type and can handle a change in the volume of the battery cell and effectively radiate heat accumulated in a battery module, and the battery module.

In one aspect, the present invention provides a heat radiation plate for a battery module, which is inserted in an interlayer manner between battery cells. The heat radiation plate includes high-polymer matrix layers and a filler layer inserted in an interlayer manner between the high-polymer matrix layers, in which the filler layer is made of a conductive fiber having a three-dimensional (3D) web structure.

Preferably in some exemplary embodiments of the present invention, a portion of the high-polymer matrix layers may be impregnated into the filler layer during injection molding to improve connectivity with the filler layer.

Also preferably, the heat radiation plate may be inserted in an interlayer manner between the adjacent battery cells, and the edge portion of the heat radiation plate may protrude from the side end of the battery cell, so that a space between edge portions of the adjacent heat radiation plates forms a flow path space through which cooled air passes.

In another aspect, the exemplary embodiment of the present invention provides a method of manufacturing a heat radiation plate for a battery module, which is inserted in an interlayer manner between battery cells. More specifically, a conductive fiber in the form of a two-dimensional (2D) web is spun via electrospinning. Next a filler layer having a three-dimensional (3D) web structure is manufactured by coupling spun conductive fibers, and forming high-polymer matrix layers by injecting a matrix resin on top and bottom surfaces of the filler layer.

Preferably, in some exemplary embodiments, the manufacturing of the filler layer may include coupling conductive fibers by using either a needle punching technique, a melt-blown technique, a thermal bonding technique, or a chemical bonding technique or a combination of one or more of these techniques.

Other aspects and preferred embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a diagram schematically showing a conventional battery module structured by depositing pouched type battery cells;

FIG. 2 is a cross-sectional view of a heat radiation plate for a battery module according to an exemplary embodiment of the present invention;

FIG. 3 is a diagram schematically showing over-molding injection of a high-polymer matrix layer in a process of manufacturing a heat radiation plate according to the exemplary present invention;

FIG. 4 is a perspective view schematically showing a battery module having a heat radiation plate according to the exemplary present invention;

FIG. 5 is a front view of a battery module of FIG. 4;

FIG. 6 is a cross-sectional view of a battery module of FIG. 4, which is viewed from top;

FIG. 7 is a cross-sectional view of a battery module of FIG. 4, which is viewed from side; and

FIG. 8 shows an SEM image of a carbon nano tube sprayed and spun from a solution outlet of a syringe pump in a process of manufacturing a heat radiation plate according to the exemplary present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

For a conventional plastic complex material for heat radiation of a battery, contact is not smoothly achieved between filler materials filled and contained in the plastic, causing heat conduction interfacial resistance. Thus, the present invention is intended to provide a heat radiation plate for a battery module in which a carbon-based conductive fiber having high thermal conductivity is made in the form of a web like a nonwoven fabric by using electro-spinning, and the carbon-based conductive fiber in the web form is inserted in an interlayer manner between high-polymer matrix layers made of plastic to form a filler layer.

The heat radiation plate according to the present invention prevents a heat conduction interfacial resistance generated due to non-contact between fillers contained in plastic of the conventional plastic complex material to improve thermal conductivity, thereby facilitating heat radiation inside and outside the battery and preventing overheating and thermal runaway, thus improving the performance of the battery overall. Furthermore, in the present invention, due to a structural feature of a filler layer in a three-dimensional (3D) web form, anisotropy of thermal conductivity generated in the conventional plastic complex material can be improved.

In addition, the heat radiation plate according to the exemplary embodiment of the present invention, by using thermoplastic elastomer (TPE) as a material for the high-polymer matrix layers, can absorb any change in the volume of the battery cell and increase the number of battery cells per unit volume with an interface part inserted in an interlayer manner between the battery cells.

Hereinafter, a heat radiation plate for a battery module and a method of manufacturing the heat radiation plate will be described in detail.

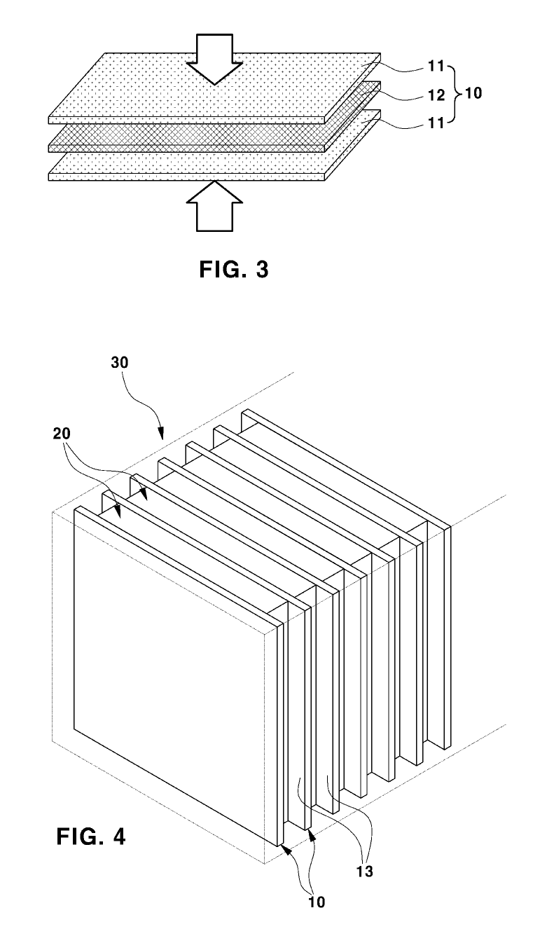

As shown in FIG. 2, a heat radiation plate 10 for a battery module according to the present invention includes a pair of high-polymer matrix layers 11 deposited on and under a filler layer 12 and the filler layer 12 inserted in an interlayer manner between the matrix layers 11. The high-polymer matrix layers 11 may be made of TPE among plastic materials to absorb changes in the volume of a battery cell which may occur during charging and discharging of the battery cell.

The filler layer 12 may be made of a carbon-based conductive fiber having a web structure to improve the heat radiation performance of the high-polymer matrix layers 11. In the carbon-based conductive fiber having a web structure, nano fibers thereof are interconnected in the form of a web to improve connectivity between the nano fibers, thus increasing thermal conductivity performance. Accordingly, the filler layer 12 improves the heat radiation performance of the high-polymer matrix layers 11 as a result of this increased heat transfer properties.

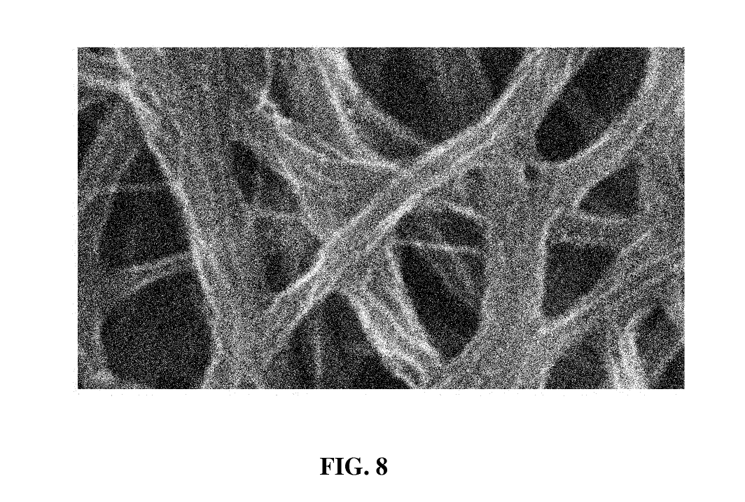

A method of manufacturing the heat radiation plate 10 structured as described above may include at least three steps. First, a carbon-based conductive fiber may be spun in the form of a web via electrospinning. In particular, the carbon-based conductive fiber is spun by spraying a spinning solution from a solution outlet of a syringe pump, and at the same time, the spinning solution may be radially spread in disorder when being sprayed while maintaining a predetermined distance (e.g., about 20 cm) or less between the solution outlet and a fiber collection portion (e.g., a portion in which the sprayed spinning solution is applied and collected on the fiber). For this reason, the two-dimensional (2D) carbon-based conductive fiber may be spun in the form of a web rather than a straight line. FIG. 8 is a scanning electron microscope (SEM) image showing a carbon nano tube sprayed and spun from the solution outlet of the syringe pump, from which it can be seen that the carbon nano tube has a 2D web structure.

Second, a carbon-based fiber felt in a thin nonwoven fabric form, e.g., the filler layer 12, is manufactured using needle punching. The conductive fiber generated through electrospinning may be manufactured in a thin felt form as the filler layer 12 inserted in an interlayer manner between (or into) the high-polymer matrix layers 11 by using any well known nonwoven fabric manufacturing method (e.g., needle punching, melt-blown, thermal bonding, chemical bonding, or the like). For example, when needle punching, the carbon-based fabric felt (filler layer) in a sheet shape having a 3D web structure, like a nonwoven fabric, is manufactured.

While needle punching, when the carbon-based conductive fiber generated by electrospinning passes through a needle loom, a needle valve to which a needle is attached reciprocates up and down so that some of fabric arrangement of a 2D random structure is coupled as a 3D random structure, and then the carbon-based conductive fiber coupled as the 3D random structure is deposited as a plurality of layers, thereby manufacturing the carbon-based fiber felt having a thickness of 0.5-2.0 mm. The carbon-based fiber felt (filler layer 12) in the form of a sheet manufactured as described above is surface-treated to improve wettablity and compatibility with the high-polymer matrix layers 11.

Third, a thermal plastic elastomer (TPE), e.g., styrene-ethylene-butylene-styrene (SEBS), is injected onto top and bottom surfaces of the filler layer 12, which has been surface-treated as described above, through overmolding as shown in FIG. 3, thus depositing the high-polymer matrix layers 11.

Since the filler layer 12 has a 3D web structure, high polymers of the high-polymer matrix layers 11, that is, the TPE is impregnated into the filler layer 12 due to a molding pressure applied in overmolding of the high-polymer matrix layers 11. In other words, the high-polymer matrix layers 11 are molded so that they are deposited on the top and bottom surfaces of the filler layer 12 and at the same time, some high polymers are impregnated into the filler layer 12 to fill spaces in the web structure of the filler layer 12. Thus, contact between the high-polymer matrix layers 11 and the filler layer 12 is smoothly achieved, thereby improving connectivity and preventing heat conduction interfacial resistance, leading to improvement in the heat radiation performance of the heat radiation plate 10. Moreover, through surface-treatment of the filler layer 12 as described above, the high polymers of the high-polymer matrix layers 11 can be more uniformly impregnated into the filler layer 12.

In this way, by forming the high-polymer matrix layers 11 on both surfaces of the filler layer 12 through overmolding injection, the heat radiation plate as shown in FIG. 2 can be manufactured.

To effectively transfer heat to the filler layer 12 between the high-polymer matrix layers 11 through the high-polymer matrix layers 11 from a heat source (battery), the heat radiation plate 10 is preferably manufactured using 60˜70 weight % of TPE and 30˜40 weight % of a carbon-based conductive fiber having a web structure. That is, the high-polymer matrix layers 11 and the filler layer 12 preferably have a weight ratio (or content ratio) of 6˜7:3˜4.

When a content of the filler layer 12 is less than the above range, thermal conductivity in a desired thickness-wise direction cannot be obtained. In contrast, when the content of the filler layer 12 exceeds the above range, it may be difficult to handle the change in the volume of the battery cell due to degradation of grip properties or elasticity in an interface with the battery cell or the efficiency of heat transfer may be lowered due to heat conduction interfacial resistance.

Herein, a material for the carbon-based conductive fiber of the filler layer 12 may be either boron nitride, graphite, carbon black, or aluminum nitride which have high thermal conductivity, or a compound of two or more selected among them.

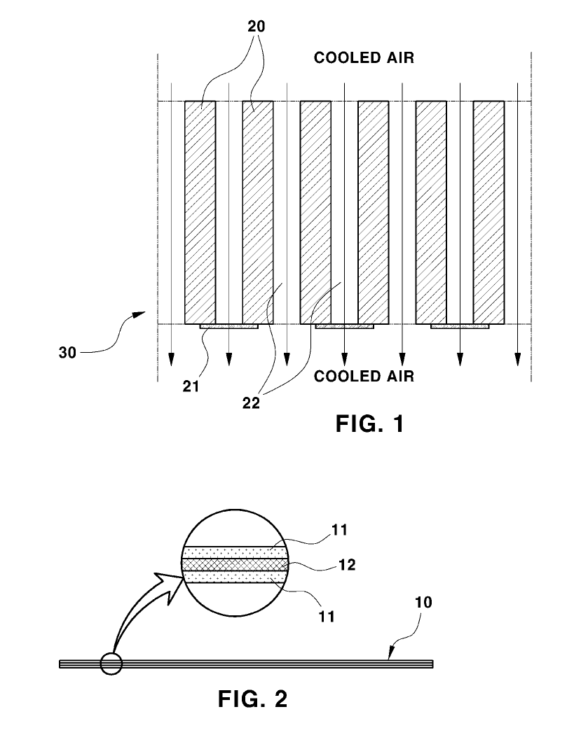

Referring to FIG. 1, a conventional battery module has to have a flow path for air to pass through and in and out between pouched type battery cells to apply an air cooling scheme for securing heat radiation property, and to form the flow path, a predetermined interval of about 3-5 mm has to be maintained between the battery cells. Thus, the number of cells within the same volume is reduces and the degree of freedom of design for improving energy density within the same volume is limited is as a result.

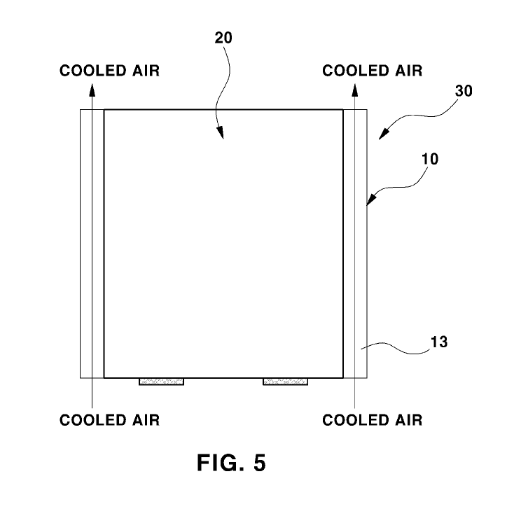

On the other hand, referring to FIGS. 4 through 7, by using the heat radiation plate 10 according to the exemplary embodiment of the present invention which has a thin thickness of 0.5-2.0 mm without a need to form a separate flow path for applying an air cooling scheme between the battery cells 20 in the battery module 30, an interval between the battery cells 20 can be reduced and thus energy density with respect to the same volume can also be improved.

Moreover, as to the battery module 30 having the heat radiation plate 10 according to the exemplary embodiment of the present invention, when flow path's direction and space are formed perpendicular to the deposition direction of the heat radiation plate 10, the flow of heat radiation is smooth without interruption through the 3D network (or web) structure, thereby improving the efficiency of heat radiation in comparison to the air cooling scheme used in the conventional battery module.

Advantageously, the heat radiation plate 10 according to the present invention has a thermal conductivity of 5 W/mk or more in the thickness-wise direction of the high-polymer matrix layers 11 and a thermal conductivity of 20 W/mk in the filler layer 12.

Furthermore, the fiber felt used in the filler layer 12 of the heat radiation plate 10 according to the exemplary embodiment of the present invention may use not only a carbon-based conductive fiber, but also a metal-based conductive fiber (e.g., 50-400 W/mk) or a conjugate fiber (e.g., 20-100 W/mk) combining a metal-based conductive fiber and a carbon-based conductive fiber, and in this case, the thermal conductivity of the filler layer 12 can be further improved.

As a material for the high-polymer matrix layers 11 of the heat radiation plate 10, TPE may be used, and more specifically, either polyolefin-based, polyurethane-based, polystyrene-based, or polyamide-based materials or a compound of two or more of them may be used. Among them, styrene-ethylene-butylene-styrene (SEBS) is preferably used as the material for the high-polymer matrix layers 11.

The heat radiation plate 10 for the battery module according to the present invention, manufactured as described above, is mainly characterized in that the filler layer 12 in the nonwoven fabric form, which is manufactured using a carbon-based and/or metal-based conductive fiber having a web structure, is inserted in an interlayer manner between the high-polymer matrix layers 11.

In an exemplary embodiment of the present invention, a battery module configured as shown in FIG. 4 can be manufactured by using the heat radiation plate 10. Referring to FIGS. 4 through 7, the battery module 30 having the heat radiation plate 10 according to the exemplary embodiment of the present invention may include a plurality of battery cells 20 and the plurality of heat radiation plates 10 which are inserted in an interlayer manner between the battery cells 20, respectively.

The plurality of battery cells 20 may be deposited between the heat radiation plates 10 to form the single module 30. To effectively transfer heat generated in each cell 20 to the heat radiation plate 10 interposed in a closely contacting manner between the cells 20, the plurality of battery cells 20 may be deposited so that the cells 20 are in direct contact and are directly bonded with the heat radiation plate 10 therebetween.

The heat radiation plate 10 is manufactured to be larger than the battery cell 20 by a predetermined width, such that an edge portion 13 of the heat radiation plate 10 inserted in an interlayer manner between the cells 20 protrudes outwardly from the cell 20 by the predetermined width.

In this way, the edge portion 13 of the heat radiation plate 10 protrudes from left and right sides (relative to FIGS. 4-7) of the cell 20, such that when the module 30 combining the cells 20 and the heat radiation plates 10 are mounted in a battery pack, a sufficient flow path space (cooling flow path for heat radiation) for allowing the cooled air to flow may be formed between the edge portions 13 of the adjacent heat radiation plates 10.

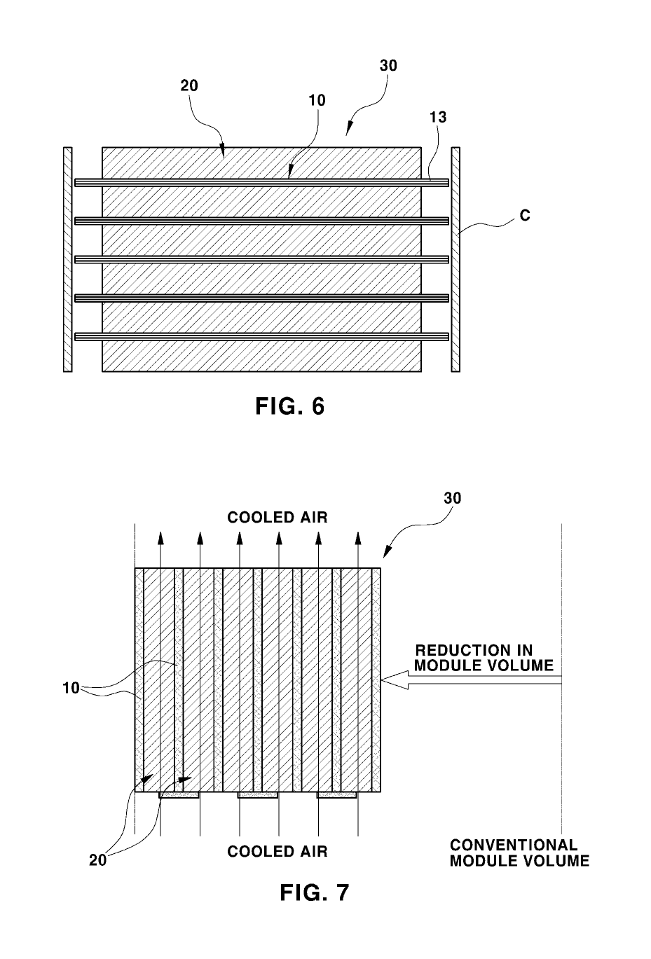

As shown in FIG. 6, the flow path space is formed perpendicular to the deposition direction of the battery cells 20, and may be formed to be surrounded by the heat radiation plates 10 of the battery module 30 and a battery pack case C or may be formed as a space between a plurality of battery modules mounted in the battery pack case C. Through the cooled air passing through the flow path space, the heat from the battery module 30 is radiated. That is, when the cooled air passes through a space between the edge portions 13 of the adjacent heat radiation plates 10, heat, which is generated in the cell 20 and is transferred to the edge portions 13 of the heat radiation plates 10, is transferred and is finally radiated to outside through the cooled air.

The heat radiation plate for the battery module according to the exemplary embodiment of the present invention is configured so that the high thermal conductive filler layer in the nonwoven fabric form is inserted into the high-polymer matrix layers, thereby improving thermal conductivity of in-plane and thru-plane and thus improving the heat radiation property of the battery module when compared to prior art as an interfacial part inserted in an interlayer manner between the battery cells. Therefore, the heat radiation plate according to the exemplary embodiment of the present invention can prevent overheating and thermal runaway of the battery and increase the efficiency of the battery, thereby improving the salability of an electric vehicle which adopts the exemplary heat radiation plate in its battery module. Moreover, by using the heat radiation plate according to the exemplary embodiment of the present invention, the heat radiation system of the battery can be made more compact and thus the battery may also be configured to be more compact as well.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A heat radiation plate for a battery module comprising:
high-polymer matrix layers; and
a filler layer inserted in an interlayer manner between the high-polymer matrix layers,
wherein the filler layer is made of a conductive fiber having a three-dimensional (3D) web structure, and
the heat radiation plate is inserted in an interlayer manner between adjacent battery cells of the battery module.

2. The heat radiation plate of claim 1, wherein a portion of the high-polymer matrix layers is impregnated into the filler layer during injection molding improving connectivity with the filler layer.

3. The heat radiation plate of claim 1, wherein the high-polymer matrix layers and the filler layer have a weight ratio of 6˜7:3˜4.

4. The heat radiation plate of claim 1, wherein a material for the filler layer is selected from a group consisting of a carbon-based conductive fiber and a metal-based conductive fiber or a compound of two or more selected from among them.

5. The heat radiation plate of claim 1, wherein a material for the filler layer is selected from a group consisting of boron nitride, graphite, carbon black, and aluminum nitride or a compound of two or more selected from among them.

6. The heat radiation plate of claim 1, wherein thermoplastic elastomer (TPE) is used as a material for the high-polymer matrix layers.

7. The heat radiation plate of claim 1, wherein a material for the high-polymer matrix layers is selected form a group consisting of polyolefin-based, polyurethane-based, polystyrene-based, and polyamide-based materials or a compound of two or more of them.

8. The heat radiation plate of claim 1, wherein styrene-ethylene-butylene-styrene (SEBS) is used as a material for the high-polymer matrix layers.

9. The heat radiation plate of claim 1, wherein the filler layer has a thermal conductivity of 20 W/mk or more.

10. The heat radiation plate of claim 1, wherein the filler layer has a thickness of 0.5-2.0 mm.

11. The heat radiation plate of claim 1, wherein an edge portion of the heat radiation plate protrudes from a side end of the battery cell.

12. The heat radiation plate of any one of claim 1, wherein the heat radiation plate is inserted in an interlayer manner between the adjacent battery cells, and the edge portion of the heat radiation plate protrudes from a side end of the battery cell, so that a space between edge portions of the adjacent heat radiation plates form a flow path space through which cooled air passes.

13. A method of manufacturing a heat radiation plate for a battery module, which is inserted in an interlayer manner between battery cells, the method comprising:
spinning a conductive fiber in the form of a two-dimensional (2D) web via electrospinning;
manufacturing a filler layer having a three-dimensional (3D) web structure by coupling spun conductive fibers; and
forming high-polymer matrix layers by injecting a matrix resin on top and bottom surfaces of the filler layer to form the heat radiation plate.

14. The method of claim 13, further comprising:
before forming the high-polymer matrix layers, performing surface-treatment on the filler layer by using a treatment selected from a group consisting of plasma treatment, thermal treatment, and ion injection treatment.

15. The method of claim 13, wherein the manufacturing of the filler layer comprises coupling conductive fibers by using a technique selected from a group consisting of needle punching, melt-blown, thermal bonding, and chemical bonding.

16. The method of claim 13, wherein the high-polymer matrix layers and the filler layer have a weight ratio of 6-7:3-4.

17. The method of claim 13, wherein a material for the filler layer is selected from a group consisting of a carbon-based conductive fiber and a metal-based conductive fiber or a compound of two or more selected from among them.

18. The method of claim 13, wherein a material for the filler layer is selected from a group consisting of boron nitride, graphite, carbon black, and aluminum nitride or a compound of two or more selected from among them.

19. The method of claim 13, wherein thermoplastic elastomer (TPE) is used as a material for the high-polymer matrix layers.

20. The method of claim 13, wherein a material for the high-polymer matrix layers is selected from a group consisting of polyolefin-based, polyurethane-based, polystyrene-based, and polyamide-based materials or a compound of two or more of them.

21. The method of claim 13, wherein styrene-ethylene-butylene-styrene (SEBS) is used as a material for the high-polymer matrix layers.
